(19) United States
(12) Patent Application Publication
(10) Pub. No.: US 2018/0121886 A1
(43) Pub. Date: May 3, 2018

(54) THEATER CONTROL SYSTEM AND METHOD

(71) Applicant: CJ CGV CO., LTD., Seoul (KR)

(72) Inventors: Soo Jin KIM, Goyang-si (KR); Wayne OHM, Paju-si (KR)

(21) Appl. No.: 15/568,968

(22) PCT Filed: Apr. 29, 2016
(86) PCT No.: PCT/KR2016/004563

§ 371 Date: Oct. 24, 2017

(30) Foreign Application Priority Data
Apr. 29, 2015 (KR) 10-2015-0060549

(51) Int. Cl. G06Q 10/00; H04L 29/08; A63J 25/00

(52) U.S. Cl. CPC G06Q 10/20; A63J 2005/002; A63J 25/00; H04L 67/125

(57) ABSTRACT

The present invention relates to a system and method for collecting, by a single server, an overall situation of theaters operating in various areas nationwide or all over the world, for example, state information, maintenance and repair information about each theater, and theater information of screening-related devices and for enabling a user to control a plurality of theaters using such pieces of information. To this end, the present invention includes a theater server included in each theater and a control server configured to receive a variety of pieces of information from the theater server and process the information.

### TECHNICAL FIELD

The present invention relates to a system and method for collecting, by a single server, an overall situation of theaters operating in various areas nationwide or all over the world, for example, state information, maintenance and repair information about each theater, and theater information of screening-related devices and for enabling a user to control a plurality of theaters using such pieces of information. To this end, the present invention includes a theater server included in each theater and a control server configured to receive a variety of pieces of information from the theater server and process the information.

### BACKGROUND ART

As movie content is recently diversified, the number of theaters, that is, a space in which the movie content can be viewed, is greatly increased.

Today, many theaters are equipped with various screening-related devices in order to implement various effects and a realistic content playback environment for audiences. In this case, the various screening-related devices include a cinema server for managing content played back in a theater, effect devices for providing various special effects, and motion chairs for providing stereoscopic motions to audiences. In managing a theater equipped with such complicated and various screening-related devices, there is a need to collect and record state information about each of the devices in real time, but in most of theaters, only individual maintenance and repair is performed without an integrated management system for such devices.

Recently, one theater service operator owns and manages a plurality of theaters. In particular, a movie business area is extended to foreign countries in addition to a specific country, and such theaters continue to be installed in foreign countries. In such a condition, a theater service operator at one place needs to monitor and control the operating situation of all of theaters nationwide or all over the world, but such a wide monitoring system has not yet been implemented.

An embodiment of the present invention relates to a theater control system and method for monitoring an overall operating state of theaters distributed widely as described above, in particular, a normal driving state of devices included in each theater and for monitoring the maintenance and repair ability for each theater. The present invention has been invented to satisfy the aforementioned technical needs and to provide additional elements which may not be easily invented by those skilled in the art.

### DISCLOSURE

### Technical Problem

An object of the present invention is to provide a theater control system and method for enabling a user who manages a plurality of theaters to monitor the real-time operating state of all the theaters and for transferring a control command to the user according to circumstances.

In particular, an object of the present invention is to enable a user to easily check the operating state of all of theaters by collecting state information about various screening-related devices included in each of the theaters in real time and transmitting the state information to a control server so that such information is concentrated upon the control server.

Furthermore, an object of the present invention is to provide a theater control system and method for helping a user to properly handle a situation by further collecting maintenance and repair information about each theater or information about each theater in addition to current state information for each theater.

### Technical Solution

In accordance with an aspect, a proposed theater control system includes a theater server configured to collect state information from screening-related devices included in a theater, generate a state message based on the state information, and transmit the generated state message to a control server and the control server configured to receive the state message from the theater server, extract state information from the state message, and provide the extracted state information to a user.

Furthermore, in the theater control system, the state information may include at least one of device error information, screening schedule information, current screening information, administrator input information, and KDM reception state information.

Furthermore, in the theater control system, the state message may further include theater information. In this case, the theater information may include any one of a theater identifier, a telephone number, an address, the number of screens, and installed screening-related devices.

Furthermore, in the theater control system, the state message may further include maintenance and repair information. In this case, the maintenance and repair information may include any one of a maintenance and repair request date and hour, a theater that has requested maintenance and repair, a target maintenance and repair theater, maintenance and repair request contents, maintenance and repair processing results, the inventory of devices for maintenance and repair, the storage and delivery history of devices for maintenance and repair, and the vendors of devices for maintenance and repair.

Furthermore, in the theater control system, the screening-related devices may include at least one of an effect device, a motion chair, a projection device, and a cinema server.

Furthermore, in the theater control system, the control server may receive a control command for controlling one or more of the screening-related devices from the user and transmit the control command to the theater server of a corresponding theater.

A control server according to an embodiment of the present invention includes a reception unit configured to receive a state message including state information about screening-related devices within a theater from a theater server and a state information management unit configured to extract state information from the state message and to provide the extracted state information to a user.

Furthermore, in the control server, the state information management unit may transmit a notification message to a theater or theater administrator corresponding to the state message if device error information is included in the state message.

Furthermore, in the control server, the state message may further include theater information. Furthermore, the control server may further include a theater information management unit configured to extract the theater information from the state message and to provide the extracted theater information to the user.

Furthermore, in the control server, the state message may further include maintenance and repair information. Furthermore, the control server may further include a maintenance and repair management unit configured to extract the maintenance and repair information from the state message and to provide the extracted maintenance and repair information to the user.

Furthermore, the control server may further include an access management unit configured to receive an access request from a user terminal and to determine whether the user terminal has access rights and an information providing unit configured to provide the state information to the user terminal if the user terminal has legitimate access rights.

Furthermore, the control server may further include a control unit configured to receive a control command from a user terminal and to transmit the control command to one or more theater servers.

A method for controlling, by a control server, theaters according to an embodiment of the present invention includes receiving a state message including state information about attached devices within a theater, extracting the state information from the state message, and providing the extracted state information.

The method may further include transmitting a notification message to a theater or theater administrator corresponding to the state message if device error information is included in the state message.

Furthermore, the method may further include receiving an access request from a user terminal and checks whether the user terminal has access rights and providing the state information to the user terminal if the user terminal has the access rights.

Furthermore, the method may further include receiving a control command from a user terminal and transmitting the control command to one or more theater servers.

### Advantageous Effects

In accordance with an embodiment of the present invention, there is an advantage in that a plurality of theaters can be easily managed because the real-time operating state of a plurality of theaters can be monitored and a control command can be transferred according to circumstances.

Furthermore, in accordance with an embodiment of the present invention, there is an advantage in that a user, that is, an operator who manages a plurality of theaters, can manage each of the theaters more specifically because the state information of each of screening-related devices included in each of the theaters can be checked.

### DESCRIPTION OF DRAWINGS

FIG. 1 shows a schematic configuration of a theater control system according to an embodiment of the present invention.

FIG. 2 shows an example of a network connection between a theater server and screening-related devices within a single theater.

FIG. 3 is a block diagram showing detailed elements of a control server according to an embodiment of the present invention.

FIG. 4 is a flowchart illustrating a theater control method according to an embodiment of the present invention.

FIG. 5 shows an embodiment in which generic state information about a plurality of theaters has been displayed.

FIGS. 6 to 8 show embodiments in which device error information about screening-related devices included in each theater has been displayed.

FIGS. 9 to 10 are embodiments in which content playback schedules and KDM reception state for each theater have been displayed.

FIG. 11 shows an embodiment in which information about theaters has been displayed.

FIGS. 12 and 13 show embodiments in which maintenance and repair information has been displayed.

### MODE FOR INVENTION

The details of the objects and technical configurations of the present invention and acting effects thereof will be more clearly understood from the following detailed description based on the accompanying drawings. Hereinafter, embodiments of the present invention are described in detail with reference to the accompanying drawings.

The embodiments disclosed in this specification should not be construed or used as limiting the scope of the present invention. It is evident to those skilled in the art that a description including the embodiments of this specification may have various applications. Accordingly, some embodiments described in the detailed description of the present invention are illustrative for better understanding, and the scope of the present invention is not intended to be restricted by the embodiments.

Functional blocks illustrated in the drawings and described hereunder are only examples of possible implementations. In other implementations, other functional blocks may be used without departing from the spirit and scope of the detailed description. Furthermore, one or more functional blocks of the present invention are illustrated as separate blocks, but one or more of the functional blocks of the present invention may be a combination of various hardware and software elements for executing the same function.

Furthermore, it should be understood that an expression that some elements are included is an expression of an open type and the expression simply denotes that the corresponding elements are present, but does not exclude additional elements.

Furthermore, when one element is described as being connected or coupled to the other element, it should be understood that one element may be directly connected or coupled to the other element, but a third element may be interposed between the two elements.

Furthermore, a theater described in the present invention should be construed as being a space, including a projection plane, such as a screen for playing back content, a projection device 130, such as a projector, effect devices 110, motion chairs 120, and a cinema server 140. In particular, if a plurality of theaters is included in one place, this is referred to as a “site.” For example, a Gangnam site should be construed as including a plurality of theaters, such as a theater 1 to a theater 9.

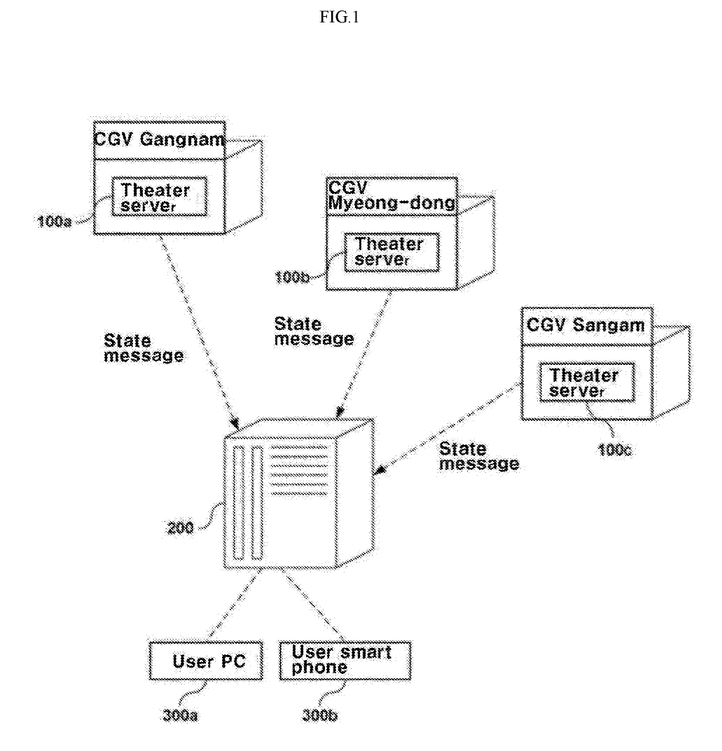

A theater control system according to an embodiment of the present invention is schematically described below with reference to FIGS. 1 and 2.

As described above, the theater control system according to an embodiment of the present invention is a system for monitoring theaters installed in a wide area in a lump, and it includes a theater server 100 and a control server 200, that is, core elements. Furthermore, the system may further include a user terminal 300, such as a user PC and a user smart phone for accessing the control server 200 and checking state information about each of theaters.

First, the theater server 100 is described below.

The theater server 100 is included in each theater and functions to manage screening-related devices installed in each theater. More specifically, the theater server 100 receives state information from screening-related devices, generates a state message based on the state information, and transmits the generated state message to the control server 200.

In this case, the screening-related devices refer to a variety of types of devices for providing audiences with a screening service in each theater. FIG. 2 shows an example in which screening-related devices have been installed in a theater.

Referring to FIG. 2, each theater may include the effect devices 110, the motion chairs 120, and the projection device 130 in order to provide audiences with a content screening service, and may further include the cinema server 140.

The effect devices 110 provide audiences with effects, such as lighting and air-conditioning, within a theater simultaneously with the playback of content. The effect devices may include theater light devices and air-conditioning devices. Recently, special effect devices for increasing a feeling of immersion are installed within a theater. In a broad sense, the effect devices 110 may include special effect devices for 4D content screening, for example, a water spray device, a fog device, a bubble device, and a fan.

The motion chairs 120 are installed in a theater, in particular, within a 4D theater. The motion chair is a screening-related device for providing a motion to a seated audience in various directions. The motion chair 120 may be driven in various aspects, such as roll, pitch, yaw, heave, sway, and surge. Furthermore, the intensity of a movement of the motion chair can also be controlled.

The motion chair 120 is not limited and installed only in a 4D theater. For example, in a common content theater, a chair in which an audience can control the height of a seat and the distance between the front and the rear by adjusting his or her position should also be construed as belonging to the scope of the motion chair 120.

The projection device 130 refers to a device for projecting a content playback screen to a projection plane. An embodiment of the present invention is not limited to one projection device 130. The theater may include a plurality of projection planes installed to surround seats and a plurality of the projection devices 130 configured to project content onto the respective projection planes, thereby being capable of providing a more realistic content watching environment to audiences.

The cinema server 140 is a device for receiving external cinema content data and playing back the received cinema content data. The cinema server 140 plays back cinema content data according to a predetermined organization schedule a specific theater for a specific time at a specific point of time.

In this case, the cinema server 140 receives a key delivery message (KDM) from an external server, such as a content distribution server. The KDM is content security data for managing the storage and screening of content. The cinema server 140 may play back content stored in the cinema server only when the KDM is legally received.

As will be described later, an operating subject who provides a screening service, that is, a user according to an embodiment of the present invention, may need to continue to check whether a KDM is smoothly received in real time with respect to a specific theater in which cinema content is played back and thus whether the cinema content is played back in time. An embodiment of the present invention provides related information (e.g., a screening schedule and a KDM reception state) in response to such a need from a user.

Referring to FIG. 2, a variety of screening-related devices which may be included in one theater, such as that described above, is connected to one theater server 100 over wired and/or wireless networks. Each of the screening-related devices transfers its state information to the theater server 100 in real time or in a specific cycle.

The theater server 100 according to an embodiment of the present invention receives state information from the screening-related devices and generates a state message based on the received state information.

The state message means that the contents of the state information have been recorded over time. In particular, in an embodiment of the present invention, the state message is generated in the form of a single unified standard. Such a state message is used as a source from which the control server 200 extracts state information. If an error occurs in screening-related devices within each theater, the state message helps with giving a control command for a corresponding screening-related device. In particular, the state message is usefully used to find the cause of a corresponding error that has occurred.

The theater server 100 may include a variety of pieces of information in a state message based on state information received from each screening-related device.

For example, when state information is received from the cinema server 140, a state message generated by the theater server 100 may include a title, a screening day, a screening time, a running time, the number of showings of cinema content and/or whether screening will be performed.

For another example, when state information is received from the effect devices 110, the motion chairs 120, the projection device 130, and the cinema server 140, a state message may include so-called device error information by which whether an error has occurred in a device and the contents of an error can be checked, such as whether a driving error has occurred, a part in which a driving error has occurred, driving error code, and a normal driving rate.

Whether a driving error has occurred, a part in which a driving error has occurred, and driving error code are pieces of information indicative of whether there is a part that belongs to various parts forming each device and that has an error, that an error has occurred in which part if the error has occurred, and that which error has occurred in a corresponding part, respectively.

The device error information is included in a single state message and transmitted to the control server 200. The control server 200 provides such pieces of information to a user.

The theater server 100 generates a state message using such a method and transmits the state message to the control server 200. In this case, the state message is transmitted from the theater server 100 to the control server 200 through the Internet.

As may be seen from FIG. 1, in general, one 4D theater is equipped with one theater server 100. The theater servers 100 (e.g., 100a, 100b, 100c, . . . ) of 4D theaters installed in respective areas (e.g., CGV Gangnam, CGV Myeong-dong, CGV Sangam, . . . ) transmit state messages to the control server 200 in real time or in a predetermined cycle.

The state message transmitted from the theater server 100 to the control server 200 may include theater information about each theater in addition to the state information.

The theater information generally refers to information about a corresponding theater. In this case, the theater information may include information, such as a theater identifier for identifying a corresponding theater, an address in which the theater is placed, and a telephone number. Furthermore, the theater information may further include information about the standard and specifications of a corresponding theater, such as the number of screens included in the theater, screening-related devices installed in the theater, and the size of the theater.

The control server 200 receives a state message including theater information, such as that described above, extracts theater information, such as that described above, from the state message, and provides the extracted theater information to a user.

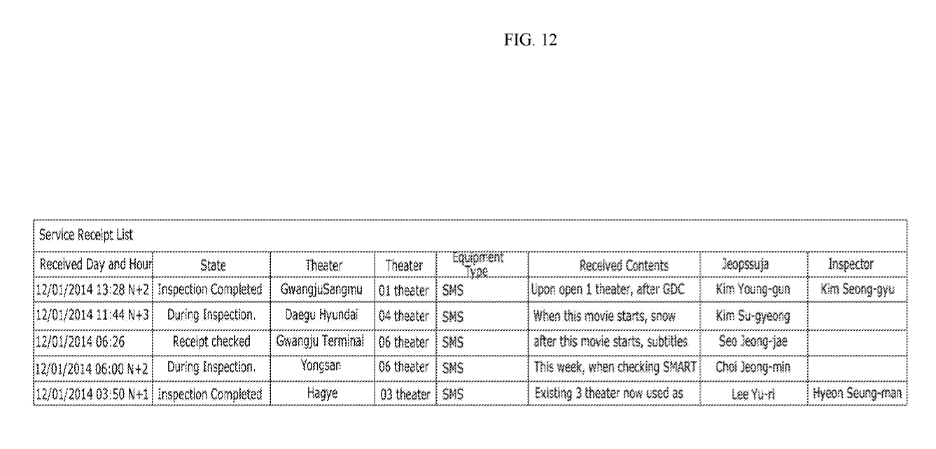

The provision of theater information by the control server 200 is described in detail later with reference to FIG. 12.

The control server 200 may autonomously generate maintenance and repair information and provide it to a user.

The maintenance and repair information may be generated by the control server 200 based on state messages received from the theater servers 100 and contents directly inputted by a user. In this case, if an error has occurred in a specific screening management device of a specific theater, the maintenance and repair information may include pieces of information related to a maintenance and repair request that requests the repair of the error.

For example, the maintenance and repair information may include a maintenance and repair request date and hour, a theater that has requested maintenance and repair, a target maintenance and repair device, and maintenance and repair request contents. The maintenance and repair information may further include information, such as a current inventory of devices for maintenance and repair within a corresponding theater, the storage or delivery history of devices for maintenance and repair, and the vendors of devices for maintenance and repair.

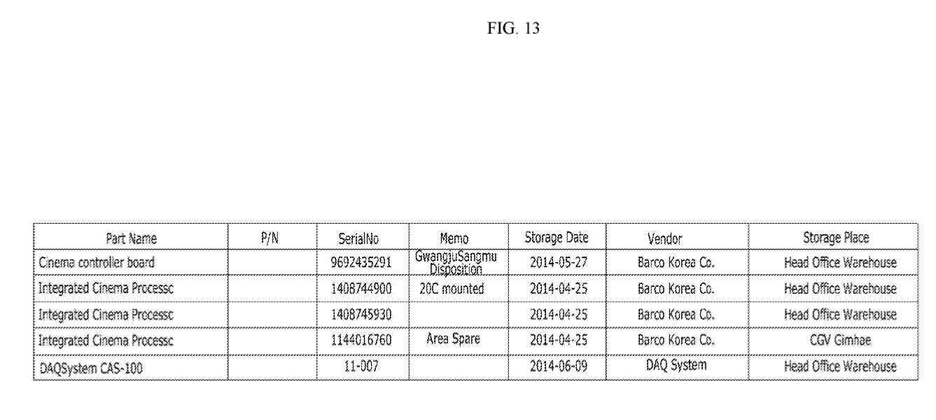

The generation and provision of maintenance and repair information by the control server 200 is described in detail later with reference to FIGS. 13 to 15.

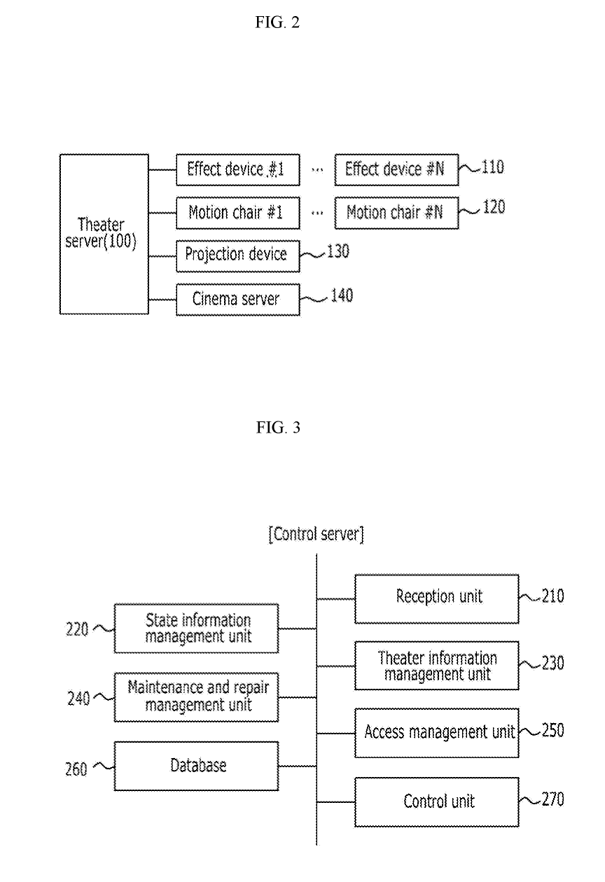

The control server 200 according to an embodiment of the present invention is described below with reference to FIGS. 1 and 3.

Referring to FIG. 1, the control server 200 functions to receive a state message from each of the plurality of theater servers 100, to extract state information from the received state message, and to provide the extracted state information to a user. In this case, the provision of the state information to the user should be construed as meaning that the state information is displayed on a display device (or monitor) connected to the control server 200 and that the state information is transmitted to the user terminal 300 connected to the control server 200 over a network, such as a smart phone or a PC, and displayed on the user terminal 300.

That is, the control server 200 refers to a device for collecting data (or state messages) capable of checking the internal operating state of theaters from the theaters installed nationwide or all over the world and comprehensively managing the data. In this case, the operating state of a plurality of theaters installed in a wide area can be managed in one device.

The control server 200 according to an embodiment of the present invention is not limited to only the function for receiving state messages from the theater servers 100. The control server 200 may receive a control command capable of controlling each of theaters, more precisely, screening-related devices included in each theater from a user, and may transmit the control command to the theater server 100. That is, the theater monitoring system according to an embodiment of the present invention includes a state information report system from the theater servers 100 to the control server 200 and a control command transfer system from the control server 200 to each of the theater servers 100, thereby enabling a user to perform interactive communication.

Referring to FIG. 3, the control server 200 according to an embodiment of the present invention includes a reception unit 210, a state information management unit 220, a theater information management unit 230, a maintenance and repair management unit 240, an access management unit 250, a database 260, and a control unit 270. In this case, the control server 200 may essentially include the reception unit 210 and the state information management unit 220, and may optionally include the maintenance and repair management unit 240, the theater information management unit 230, the access management unit 250, the database 260, and the control unit 270.

First, the reception unit 210 receives a state message, including state information about screening-related devices included in each theater, from each of the plurality of theater servers 100. In this case, the state message corresponds to a specific theater or a specific theater server 100 and includes a theater identifier for identifying the theater or the theater server 100. A theater name or theater unique code may be used as the identifier.

The state information management unit 220 extracts state information from the received state message and provides the extracted state information to a user.

The state information management unit 220 restores the state information by decoding the state message received from the theater server 100, and displays the restored state information on a display device connected to the control server 200 or provides the restored state information to a user in such a way as to transmit the restored state information to the user terminal 300 over a network.

Furthermore, the state information management unit 220 may cumulatively record the extracted state information, that is, the restored state information, by storing it in the database 260 of the control server 200.

The state information may include device error information, maintenance and repair request information, screening schedule information, current screening information and/or KDM reception state information. The pieces of information are collected from screening-related devices included in each theater, that is, the effect devices 110, the motion chairs 120, the projection device 130, and the cinema server 140.

The device error information refers to information about a corresponding error if the error has occurred in a corresponding screening-related device. More specifically, the device error information may include information, such as whether an error has occurred, the type of device in which an error has occurred, an identifier (or a device serial number), a kind of an error, and an error occurrence time.

If device error information, that is, information, such as the occurrence of a driving error in a corresponding screening-related device, a part in which a driving error has occurred, or driving error code, is included in a state message, the state information management unit 220 may be configured to transmit a notification message to an administrator who manages a theater or the theater server 100 of the theater corresponding to the state message.

The control server 200 checks state information about each theater in real time or in a specific cycle and automatically notifies a corresponding theater server 100 or administrator of error information if the error information is included in the state information so that a problem can be rapidly solved.

The theater information management unit 230 functions to extract theater information from a state message and to provide the extracted theater information to a user.

In this case, the theater information may include information, such as a theater identifier for identifying each theater, an address in which the theater is placed, and a telephone number. The theater information may further include information about the standard and specifications of each theater, such as the number of screens included in the theater, screening-related devices installed the theater, and the size of the theater.

The theater information management unit 230 may request a state message, including theater information, from each theater server 100 in a predetermined cycle. When the state message is received, the theater information management unit 230 may obtain theater information from the received state message and update the theater information by cumulatively storing the obtained theater information in the database 260. For example, if the number of screens installed in a specific theater is increased or a new screening-related device is included in a specific theater, the theater information management unit 230 continues to update and manage new theater information.

The maintenance and repair management unit 240 extracts maintenance and repair information from a state message and provides the extracted maintenance and repair information to a user.

The maintenance and repair information means information related to maintenance and repair for each theater, such as that maintenance and repair, such as a repair and replacement, are necessary for a screening-related device included in a theater and whether a redundant device for repairing and replacing the screening-related device has been included.

The maintenance and repair information may optionally include information, such as a maintenance and repair request date and hour, a theater that has requested maintenance and repair, a target maintenance and repair theater, the contents of a maintenance and repair request, the inventory of devices for maintenance and repair, the storage or delivery history of devices for maintenance and repair, and the vendors of devices for maintenance and repair.

The control server 200 according to an embodiment of the present invention may further include the access management unit 250.

The access management unit 250 receives an access request from the external user terminal 300 and determines whether the user terminal 300 has access rights.

If an external user attempts to access the control server 200, the access management unit 250 confirms the access rights of the corresponding user and permits access to information stored in the database 260 only when the corresponding user has access rights.

The database 260 means a medium for storing pieces of information extracted or generated by the state information management unit 220, the theater information management unit 230, and the maintenance and repair management unit 240. The database 260 is configured to be accessible to the external user terminal 300 so that a user can easily check the current operating state of 4D theaters nationwide or all over the world.

The control server 200 according to an embodiment of the present invention may further include the control unit 270.

The control unit 270 functions to receive a control command from a user, that is, the subject who manages all of theaters and to transmit the control command to one or more theater servers 100. For example, if, as the results of the monitoring of the state information of each theater, an error is found to have occurred in an effect device 110 of a specific theater, a user may input a control command, for example, a reboot command to the control unit 270 through the input device of the control server 200 or the input unit of the user terminal 300. The control unit 270 may transmit the received control command to the theater server 100 of a corresponding theater, thereby being capable of rebooting the corresponding effect device 110.

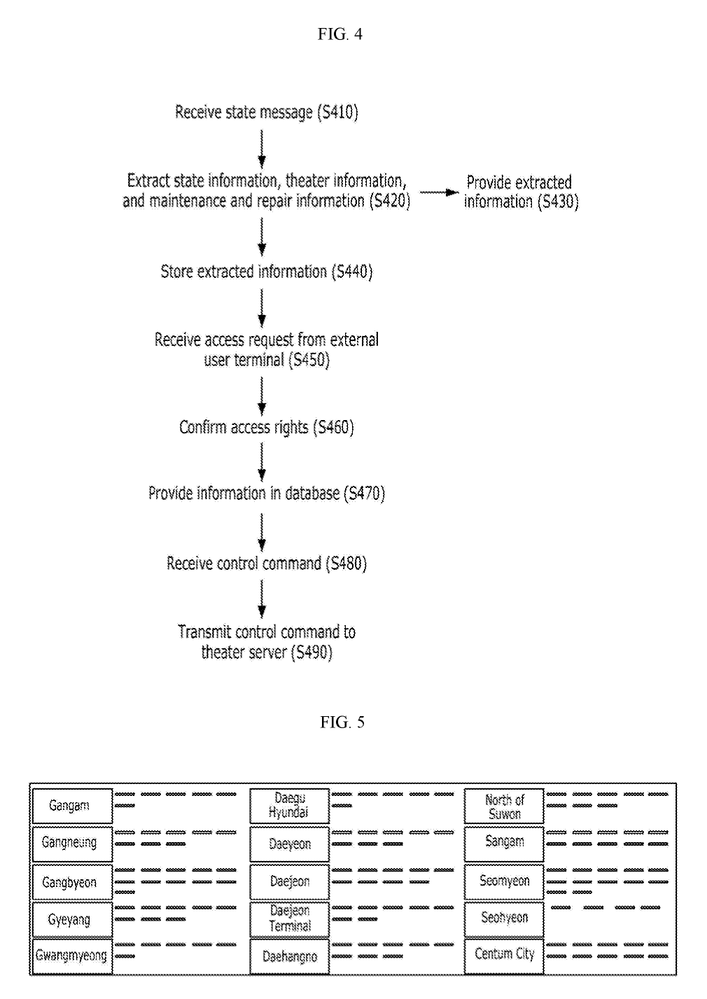

A theater control method according to an embodiment of the present invention is described below with reference to FIG. 4.

Referring to FIG. 4, in the theater control method, first, a state message including state information about screening-related devices included in each theater is received at step S410. In this case, the subject who generates the state message is the theater server 100 of each theater, and the subject who receives the state message is the control server 200. Furthermore, the state information included in the state message may be divided into various kinds depending on whether the subject who provides the state information is which screening-related device. For this, reference may be made to the description of FIG. 2.

After the state message is received, the control server 200 extracts part of or the entire state information from the state message at step S420. Extracting the state information means a process for restoring, by the control server 200, the state information included in the state message when the theater server 100 generates the state message by decoding the received state message.

In relation to S410 and S420, the state message may further include theater information and maintenance and repair information in addition to the state information. That is, the theater server 100 may use the state message as a kind of carrier. State information, theater information, and maintenance and repair information may be carried on a data format of a fixed form and periodically transmitted to the control server 200. In this case, the control server 200 can perform an information extraction task more efficiently and rapidly.

The control server 200 may directly provide the extracted state information to a user at step S430 or may store the extracted state information in the database 260 at step S440. In this case, the control server 200 may extract theater information and maintenance and repair information in addition to the state information and provide them to a user. As described above, the database 260 may allow an external user to access information stored therein, but legitimate access rights are required in order for a user to access the database 260.

That is, state information, theater information, and maintenance and repair information about each theater may be systematically stored in the database 260. The control server 200 may receive an access request from the external user terminal 300 who attempts to use pieces of information stored as described above at step S450, may perform a series of confirmation processes at step S460, and may provide the pieces of information to the user terminal 300. In this case, the user terminal 300 is not limited to a specific device if it is capable of transmitting and receiving data to and from the control server 200 over a network. For example, the user terminal 300 may include a PC, a tablet PC, a smart phone, and a PDA.

After receiving the access request, the control server 200 checks whether a corresponding user has legitimate access rights at step S460. If, as a result of the check, the corresponding user is found to have the legitimate access rights, the control server 200 provides the corresponding user with state information stored in the database 260 at step S470.

In this case, the access rights may be graded for each user, and provided state information may also be limited based on the grade. For example, a user who has access rights of a low grade may not be allowed to check state information about the cinema server 140 or may not be allowed to issue a direct control command for a specific screening-related device.

The control server 200 may receive a control command from the user terminal 300 at step S480 and transmit the control command to one or more of the theater servers 100 at step 5490.

After checking current state information about each theater, a user may transfer a command for controlling screening-related devices of each theater, if necessary. In order to meet such a need, the control server 200 functions to receive a control command from the user terminal 300 and to transfer the control command to the theater server 100 of each theater.

In this case, the control command may include a control command for any one of screening-related devices within any one theater, a control command for a plurality of theaters-related devices within any one theater, a control command for common screening-related devices within a plurality of theaters, and a control command for a plurality of screening-related devices within a plurality of theaters, and is not limited to a specific scope in which the control command may be transmitted.

An embodiment in which the theater control system according to an embodiment of the present invention provides generic state information about a plurality of theaters is described below with reference to FIG. 5.

FIG. 5 shows a list of theaters including screening-related devices and a state information page indicative of whether a driving error is present in each theater.

When a user accesses the control server 200 using the user terminal 300, the control server 200 provides state information, such as that of FIG. 5, to a user in response to a request from the user. The state information may be written in a web page form and provided in a standardized form regardless of the specifications of the user terminal 300.

The state information of FIG. 5 shows sites in which screening-related devices are now installed and operated, such as Gangnam, Gangneung, and Gangbyeon, in a list form. Furthermore, the state information may show the number of theaters included in each site in an intuitive form, for example, a bar form so that the number of theaters can be easily known. Referring to FIG. 5, 6 theaters have been illustrated as being operated in Gangnam, 8 theaters have been illustrated as being operated in Gangneung, and other sites have been illustrated in the same manner.

It may also be seen that the state information shows driving errors whether a driving error has occurred in theaters operated in each site can be easily known. For example, green is indicated in a theater that normally operates without a special problem in screening-related devices. Gray is indicated in a theater that does not now operate. Red is indicated in a theater that now operates, but has a driving error. Orange is indicated in a theater that does not now operate, but has a driving error. Accordingly, a user can easily monitor the operating state of a plurality of theaters using only the state information page.

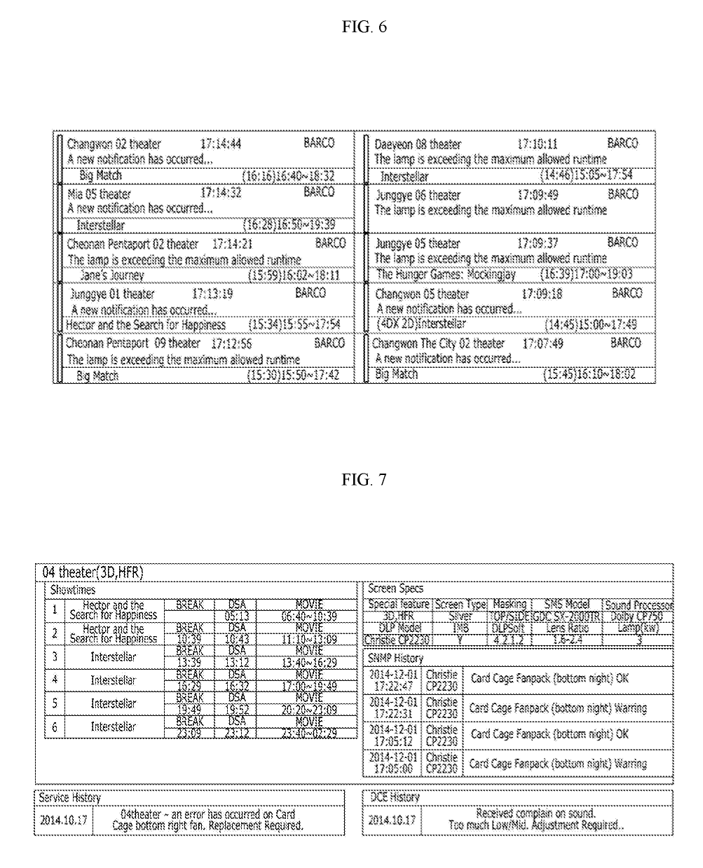

An embodiment in which device error information about screening-related devices included in each theater is described below with reference to FIGS. 6 to 8.

FIG. 6 shows a form in which state information received from a plurality of theaters in real time, that is, screening schedule information and device error information included in the state information, is displayed.

Referring to FIG. 6, a list of theaters from which device error information has been received at the present time is provided to a user. The seriousness of corresponding device error information is sorted by indicating a bar on the left of each list for each color.

For example, white is indicated in a bar if device error information has been received, but the error is not serious. Orange is indicated in a bar if device error information has been received and the error is a little serious. Red is indicated in a bar if device error information has been received and the error is very serious. Accordingly, a user can intuitively check the error situation of screening-related devices.

For example, in the case of Changwon 02 theater, a white bar is indicated on the left and only a note indicative that new device error information has been received is indicated. Furthermore, in the case of Changwon 05 theater, a note indicative that a light is being driven exceeding a maximum allowed runtime is indicated and an orange bar indicative of seriousness thereof is indicated on the left. In the case of Centum City 04 theater, a note indicative that a serious error has occurred in a card cake fan pack and a red bar is indicated on the left.

FIG. 7 shows a screen displayed when a specific theater is selected from the state information screen of FIG. 6. From FIG. 7, it may be seen that detailed information about device error information of the specific theater is displayed.

More specifically, when Centum City 04 theater having the indication of an error of red is selected in FIG. 6, device error information reception histories are arranged and displayed in a list firm (i.e., an SNMP History portion). The time when the device error information was received and the detailed contents of the device error are displayed in FIG. 7.

In FIG. 7, the state information screen may further include other pieces of state information, such as maintenance and repair request information (i.e., an Service History portion), screening schedule information and current screening information (i.e., a Showtimes portion), administrator input information (i.e., a DCE History portion), in addition to the device error information.

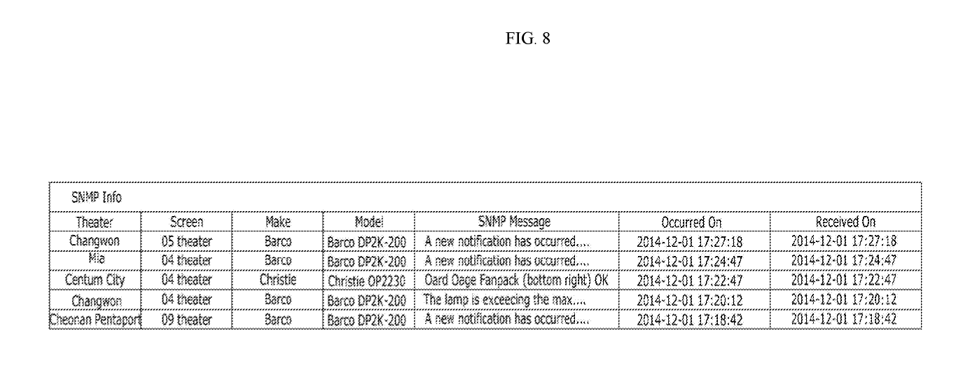

FIG. 8 shows that state information received from the plurality of theater servers 100, more specifically, device error information is displayed in real time in order of the device error information received.

From FIG. 8, it may be seen that when device error information is displayed, a site and theater identifier (i.e., a Theater and Screen portion) from which the device error information was transmitted, the identifier of a device (i.e., a Make and Model portion) in which a corresponding error was generated, the contents of the error (i.e., an SNMP Message portion), the time when the error was generated (i.e., an Occurred On portion), and the time when the device error information was received (i.e., a Received On portion) are also displayed on a screen.

Furthermore, the device error information list may be divided and indicated for each category selected by a user if only device error information about a specific site/theater and only error information about a specific device are to be checked.

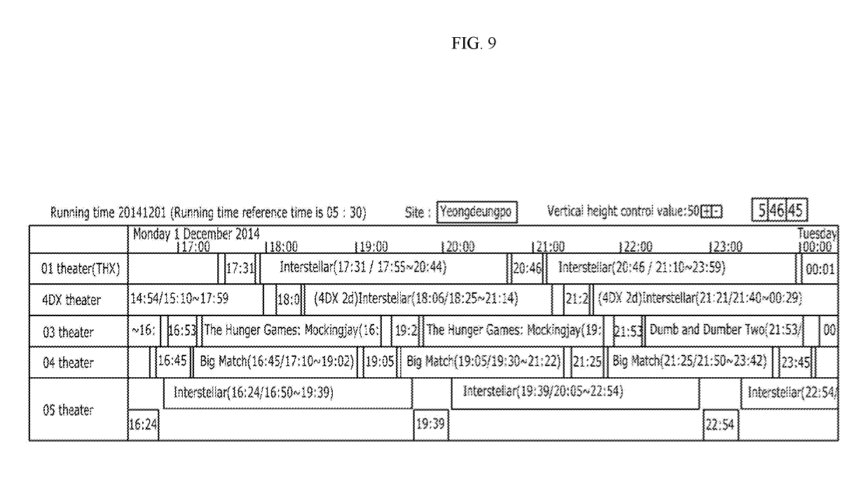

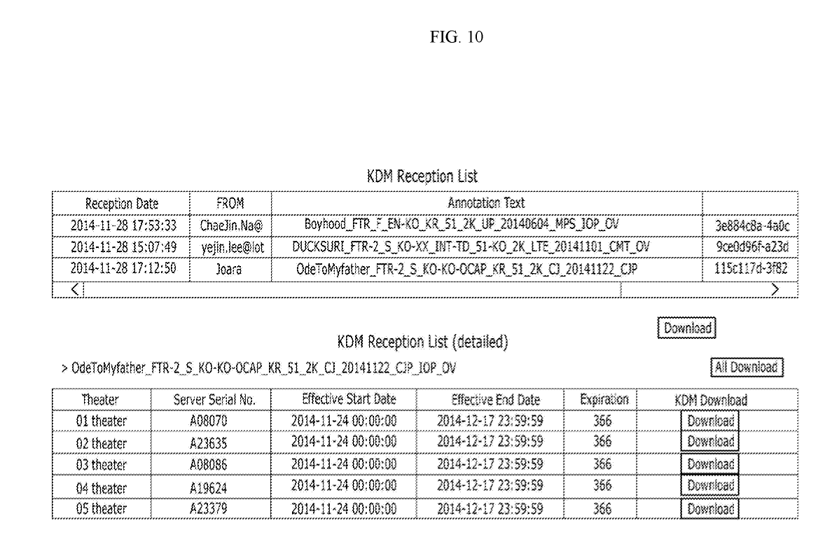

An embodiment in which content playback schedules and KDM reception state for each theater have been displayed is described below with reference to FIGS. 9 and 10.

FIG. 9 shows an embodiment in which state information received from the theater servers 100, in particular, screening schedule information included in the state information has been displayed on a screen.

Referring to FIG. 9, screening schedule information about theaters (e.g., 1 theater˜GOLD CLASS) in a Yeongdeungpo site is displayed on a single screen. From the single screen, which content is being played back in which theater at the present time can be intuitively checked.

In particular, referring to FIG. 9, a repair time prior to the start of new content after content is terminated is also displayed on the screen in addition to the playback schedule of content itself. Accordingly, a user can check subdivided screening schedule information.

FIG. 10 shows that the state in which the theater servers 100 receive key delivery messages (KDMs) from respective external servers, for example, content distributor servers is collected and displayed on a screen.

As described above, the KDM is content security data for managing the storage and screening of content. The cinema server 140 can play back content stored in the cinema server only when the KDM is legitimately received. Accordingly, a user may need to check whether KDMs within all of theaters are smoothly received. In an embodiment of the present invention, KDM reception state information is received from the theater servers 100, collected, and provided to a user, if necessary, as shown in FIG. 10.

As may be seen from FIG. 10, the KDM reception state information may include a theater identifier, the serial number of the cinema server within the specific theater, the valid period of the KDM, and information about whether the KDM has been downloaded.

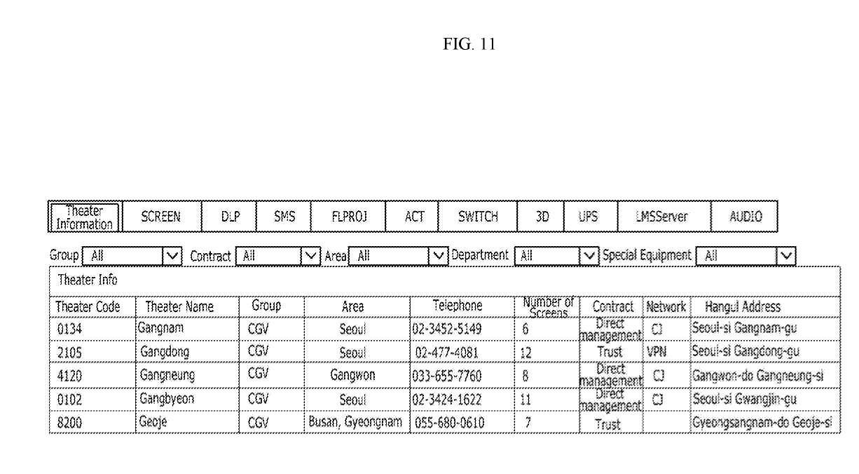

An embodiment in which information about each theater is indicated is described below with reference to FIG. 11.

FIG. 11 shows an example in which theater information provided from the control server 200 according to an embodiment of the present invention, more precisely, the theater information management unit 230 to a user is displayed on a screen. From FIG. 11, it may be seen that the theater information includes information, such as a site identifier (i.e., a Theater Code and Theater Name portion), a site address, a site telephone number, the number of screens within a site, a contract form with the site, and the subject of a network associated with the site.

In addition to the information displayed on the screen of FIG. 11, the theater information may further include detailed information about screening-related devices installed in each theater, for example, the motion chairs 120, the effect devices 110, the cinema server 140, screens, and sound devices.

An embodiment in which maintenance and repair information is displayed is described below with reference FIGS. 12 and 13.

FIG. 12 shows an example in which maintenance and repair information extracted from a state message by the control server 200 according to an embodiment of the present invention, more precisely, the maintenance and repair management unit 240 and provided to a user is displayed on a screen. From FIG. 12, it may be seen that the maintenance and repair information includes information, such as a maintenance and repair request date and hour, maintenance and repair processing results, a theater that has requested maintenance and repair, a target maintenance and repair theater, and the contents of a maintenance and repair request.

FIG. 13 shows an example in which maintenance and repair information is displayed on another screen. From FIG. 13, it may be seen that the maintenance and repair information includes information, such as the names of devices for maintenance and repair, the identifiers (i.e., serial numbers) of the devices, the inventory of devices for maintenance and repair, the storage and delivery history of the devices for maintenance and repair, the vendors of the devices for maintenance and repair, and the place where the devices for maintenance and repair has now been stored.

Although some embodiments and application examples of the present invention have been illustrated and described above, the present invention is not limited to the aforementioned specific embodiments and application examples and may be modified in various ways by those skilled in the art to which the present invention pertains without departing from the gist of the present invention written in the claims. Such modified embodiments should not be construed as being distinct from the technical spirit or prospect of the present invention.

1. A theater control system, comprising:
a theater server configured to collect state information from screening-related devices included in a theater, generate a state message based on the state information, and transmit the generated state message to a control server; and
the control server configured to receive the state message from the theater server, extract state information from the state message, and provide the extracted state information to a user.

2. The theater control system of claim 1, wherein the state information comprises at least one of device error information, screening schedule information, current screening information, administrator input information, and KDM reception state information.

3. The theater control system of claim 1, wherein the state message further comprises theater information.

4. The theater control system of claim 3, wherein the theater information comprises any one of a theater identifier, a telephone number, an address, a number of screens, and installed screening-related devices.

5. The theater control system of claim 1, wherein the state message further comprises maintenance and repair information.

6. The theater control system of claim 5, wherein the maintenance and repair information comprises any one of a maintenance and repair request date and hour, a theater that has requested maintenance and repair, a target maintenance and repair theater, maintenance and repair request contents, maintenance and repair processing results, an inventory of devices for maintenance and repair, a storage and delivery history of devices for maintenance and repair, and vendors of devices for maintenance and repair.

7. The theater control system of claim 1, wherein the screening-related devices comprise at least one of an effect device, a motion chair, a projection device, and a cinema server.

8. The theater control system of claim 1, wherein the control server receives a control command for controlling one or more of the screening-related devices from the user and transmits the control command to the theater server of a corresponding theater.

9. A control server, comprising:
a reception unit configured to receive a state message comprising state information about screening-related devices within a theater from a theater server; and
a state information management unit configured to extract state information from the state message and to provide the extracted state information to a user.

10. The control server of claim 9, wherein the state information management unit transmits a notification message to a theater or theater administrator corresponding to the state message if device error information is included in the state message.

11. The control server of claim 9, wherein:
the state message further comprises theater information, and
the control server further comprises a theater information management unit configured to extract the theater information from the state message and to provide the extracted theater information to the user.

12. The control server of claim 9, wherein:
the state message further comprises maintenance and repair information, and
the control server further comprises a maintenance and repair management unit configured to extract the maintenance and repair information from the state message and to provide the extracted maintenance and repair information to the user.

13. The control server of claim 9, further comprising:
an access management unit configured to receive an access request from a user terminal and to determine whether the user terminal has access rights; and
an information providing unit configured to provide the state information to the user terminal if the user terminal has legitimate access rights.

14. The control server of claim 9, further comprising a control unit configured to receive a control command from a user terminal and to transmit the control command to one or more theater servers.

15. A method for controlling, by a control server, theaters, comprising:
receiving a state message comprising state information about attached devices within a theater;
extracting the state information from the state message; and
providing the extracted state information.

16. The method of claim 15, further comprising transmitting a notification message to a theater or theater administrator corresponding to the state message if device error information is included in the state message.

17. The method of claim 15, further comprising:
receiving an access request from a user terminal and checks whether the user terminal has access rights; and
providing the state information to the user terminal if the user terminal has the access rights.

18. The method of claim 15, further comprising:
receiving a control command from a user terminal; and
transmitting the control command to one or more theater servers.
